(19) United States
(12) Patent Application Publication
(10) Pub. No.: US 2014/0166574 A1
(43) Pub. Date: Jun. 19, 2014

(54) BIOFILM CARRIERS AND BIOLOGICAL FILTRATION SYSTEMS INCLUDING THE SAME

(71) Applicant: Alexander Fassbender, Vienna, VA (US)

(72) Inventor: Alexander Fassbender, Vienna, VA (US)

(21) Appl. No.: 14/132,934

(22) Filed: Dec. 18, 2013

Related U.S. Application Data
(60) Provisional application No. 61/739,258, filed on Dec. 19, 2012.

(51) Int. Cl. C02F 3/10; C02F 3/02

(52) U.S. Cl. CPC C02F 3/109; C02F 3/02
USPC 210/615; 210/150; 210/541; 264/154

(57) ABSTRACT

A biological filtration system includes a reservoir configured to receive an aqueous liquid, a multiplicity of polymeric container closures in the reservoir, a fluid inlet fluidically coupled with the reservoir, and a fluid outlet fluidically coupled with the reservoir. The fluid inlet is configured such that an aqueous liquid provided to the reservoir via the fluid inlet contacts the multiplicity of polymeric container closures. The polymeric container closures support biofilm growth. Treating the aqueous liquid provided to the biological filtration system includes contacting the polymeric container closures with the aqueous liquid, growing biofilm on the polymeric container closures in contact with the aqueous liquid, thereby removing contaminants from the aqueous liquid to yield a treated aqueous liquid, and removing the treated aqueous liquid from the biological filtration system. The polymeric container closures may be reclaimed following consumer or industrial use, thereby conserving resources and reducing costs related to biofilm carriers.

### CROSS-REFERENCE TO RELATED APPLICATION

This application claims priority to U.S. Application Ser. No. 61/739,258 entitled “BIOFILM CARRIERS” and filed on Dec. 19, 2012.

### BACKGROUND

Biofilm media is used for fluid treatment in water treatment systems, such as municipal and industrial wastewater treatment systems. This biofilm media, typically formed of raw materials such as polypropylene and designed for dimensional accuracy, provides support for microbial attachment and growth in biological filtration systems. The microbes, adapted to utilize organic matter in the water in which they are found, convert carbon-containing compounds into bacterial biomass, forming a biofilm on the biofilm media. The biofilm promotes removal contaminants from the water. The biofilm media can be washed and re-used. Economic and environmental costs related to production and transportation of traditional biofilm media, however, can be high.

### SUMMARY

Polymeric container closures, such as resealable caps on consumer products, typically end up as litter. These post-consumer or discarded polymeric container closures may be reclaimed (e.g., collected or removed from a solid waste stream for re-use), and are available at low or no cost throughout the developed world. Because used polymeric container closures are ubiquitous, the cost to transport polymeric container closures from a collection facility to a site for use in a biological filtration system may also be low. Using reclaimed polymeric container closures as biofilm carriers is a way to conserve resources and reduce the costs related to biofilm media carriers for biological filtration systems.

In a first general aspect, a biological filtration system includes a reservoir configured to receive an aqueous liquid, a multiplicity of polymeric container closures in the reservoir, a fluid inlet fluidically coupled with the reservoir, and a fluid outlet fluidically coupled with the reservoir. The fluid inlet is configured such that an aqueous liquid provided to the reservoir via the fluid inlet contacts the multiplicity of polymeric container closures.

Implementations may include one or more of the following features. In some cases, the multiplicity of polymeric container closures is reclaimed (e.g., following consumer or industrial use). The polymeric container closures may be modified, for example, by one or more through holes in each polymeric container closure (e.g., through a top of each polymeric container closure), by softening (e.g., heating) and deforming the polymeric container closure, or a combination thereof. The multiplicity of polymeric container closures may include polymeric container closures in a variety of shapes, sizes, chemical composition, or any combination thereof. The multiplicity of polymeric container closures may be confined to a region of the reservoir by a porous barrier.

In some cases, the fluid inlet provides a continuous flow of the aqueous liquid to the reservoir. In certain cases, the fluid inlet provides a discontinuous or batch-wise flow of the aqueous liquid to the reservoir. The biological filtration system may include an additional fluid inlet (e.g., for providing gas to the reservoir) and an additional fluid outlet (e.g., for removing gas from the reservoir).

In a second general aspect, forming biofilm carriers for a biological filtration system includes modifying polymeric container closures to yield biofilm carriers, wherein modifying the polymeric container closures includes altering the shape of the polymeric container closures, forming one or more through holes in each of the polymeric container closures, or a combination thereof. Biofilm carriers formed by modifying polymeric container closures may be included in biological filtration systems to support biofilm growth.

In a third general aspect, treating an aqueous liquid in a biological filtration system includes providing an aqueous liquid to a biological filtration system having biofilm carriers in the form of polymeric container closures, contacting the polymeric container closures with the aqueous liquid, growing biofilm on the polymeric container closures in contact with the aqueous liquid to treat the aqueous liquid (e.g., by removing contaminants from the aqueous liquid), and removing at least some of the treated aqueous liquid from the biological filtration system.

Implementations may include one or more of the following features. The aqueous liquid may be wastewater (e.g., industrial wastewater or sewage) or any other water to be treated, and typically includes microbes and contaminants (e.g., carbon-containing compounds) that can be metabolized by the microbes. Growing the biofilm includes attaching the microbes to the polymeric container closures.

A multiplicity of container closures may be provided to the biological filtration system (e.g., before providing the aqueous liquid to the biological filtration system). The multiplicity of container closures may be reclaimed. In some cases, the multiplicity of container closures is confined to a selected region of the biological filtration system (e.g., with a porous barrier). In certain cases, the aqueous liquid is provided to the biological filtration system and the treated aqueous liquid is removed from the from the biological filtration system simultaneously. The aqueous liquid may be provided continuously or batch-wise to the biological filtration system. In some cases, a gas to be treated may be provided to the aqueous liquid, such that the gas flows through the aqueous liquid. Flowing the gas through the aqueous liquid allows contaminants (e.g., sulfur-containing compounds) to be removed from the gas via the biofilm.

The details of one or more embodiments of the invention are set forth in the accompanying drawings and the description below. Other features, objects, and advantages of the invention will be apparent from the description and drawings, and from the claims.

### DESCRIPTION OF THE DRAWINGS

FIGS. 1A-1D are images of a biofilm carriers in the form of polymeric container closures.

FIG. 2A shows nested polymeric container closures. FIG. 2B shows modification of the polymeric container closures shown in FIGS. 1A and 2B to inhibit nesting. FIG. 2C shows modification of the polymeric container closure shown in FIG. 1D to inhibit nesting.

FIG. 3A shows an exterior view of polymeric container closures with one or more through holes. FIG. 3B shows an interior view of the plastic caps shown in FIG. 3A.

FIGS. 4A-4C depict biological filtration systems.

FIG. 5 is a flow chart showing a process for treating a fluid in a biological filtration system.

FIG. 6A shows polymeric container closures in a biological filtration system, with biofilm attached to the polymeric container closures. FIG. 6B shows the polymeric container closures of FIG. 6A, with the water drained from the biological filtration system.

FIG. 7 is a plot showing chemical oxygen demand versus time for the biological filtration system shown in FIG. 6A.

FIG. 8 is a plot showing total suspended solids versus time for the biological filtration system shown in FIG. 6A

FIG. 9 is a plot showing nitrogen compounds versus time for the biological filtration system shown in FIG. 6A.

FIG. 10 is a plot showing pH versus time for the biological filtration system shown in FIG. 6A.

FIG. 11 is a plot showing dissolved oxygen versus time for the biological filtration system shown in FIG. 6A.

FIG. 12 is a plot showing oxidation/reduction potential versus time for the biological filtration system shown in FIG. 6A.

### DETAILED DESCRIPTION

As described herein, biofilm carriers for biological filtration systems include polymeric container closures. “Biofilm” generally refers to a layer of microbes held together on a surface in a self-produced matrix. “Polymeric container closure” generally refers to a plastic member designed or used to seal a container, such as a container used to hold a beverage. Examples of polymeric container closures include tops or caps for containers used to hold consumer products (e.g., food, drinks, automotive fluids, cleanser, cleaning compounds, powder, soap, wax, polish, and the like). The polymeric container closures may be resealable. In some cases, the polymeric container closures are reclaimed. As described herein, a “reclaimed” polymeric container closure generally refers to a polymeric container closure that has been discarded and collected for re-use after consumer, commercial, or industrial use. Reclaimed polymeric container closures may also referred to as “post-consumer” polymeric container closures.

Polymeric container closures suitable for biofilm carriers are available in an array of sizes, shapes, colors, and chemical composition. Polymeric container closures typically have a circular top, with a circular wall extending from the perimeter of the top. A maximum dimension of the polymeric container closure (e.g., the diameter of a circular top) may be in range between 1 cm and 20 cm, or between 2 cm and 10 cm. The top may be solid. As used herein, a “solid top” does not define through holes (i.e., liquid cannot flow from the interior of the polymeric container closure through the top to the exterior of the polymeric container closure or vice versa). In some cases, the top defines one or more through-holes. The exterior of the circular wall may be textured (e.g., with ridges or other structures) to facilitate gripping. The interior of the circular wall generally includes threads for removably coupling the polymeric container closure to mating threads on the opening of a container. The polymeric container closure interior, including threads on the circular wall, typically provides protected internal structures upon which microbes can attach. Other features, such as structures extending from the interior or exterior of the top, provide additional surfaces for microbial attachment. Polymeric container closures are typically made of high density polyethylene, polypropylene, polyethylene terephthalate, and the like.

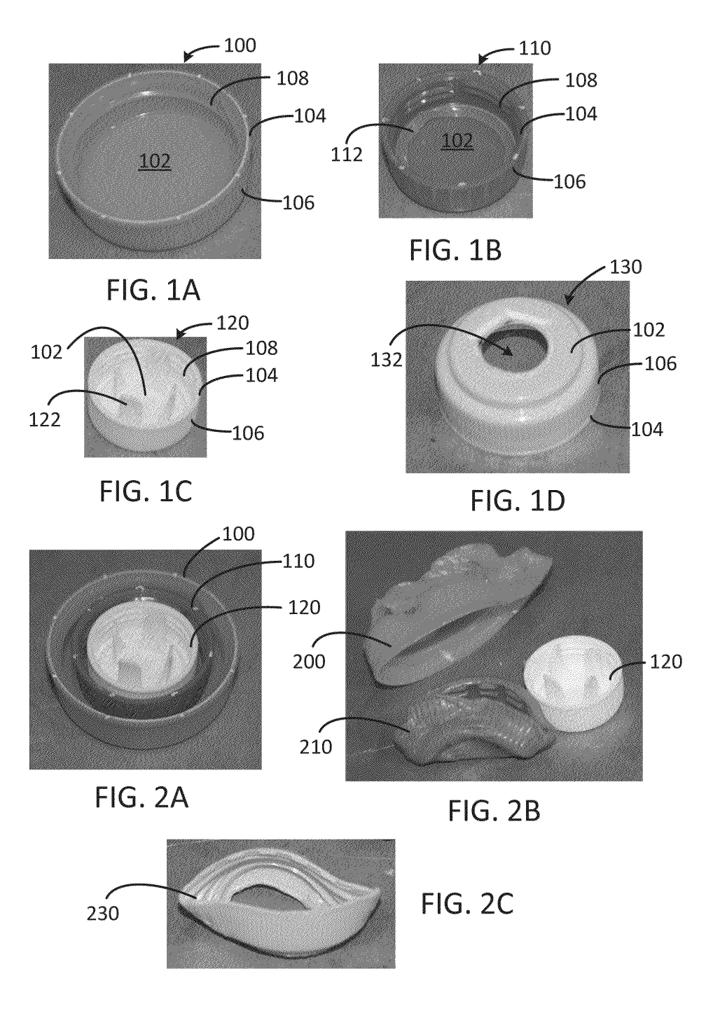

FIG. 1A shows an interior view of polymeric container closure 100, with top 102 (seen from the interior) and circular wall 104. Top 102 is solid. Ridges 106 extend from the exterior of circular wall 104, and threads 108 extend from the interior of the circular wall. FIG. 1B shows an interior view of polymeric container closure 110, with top 102 (seen from the interior) and circular wall 104. Top 102 is solid. Ridges 106 extend from the exterior of circular wall 104, and threads 108 extend from the interior of the circular wall. Seal ring 112 is visible on the interior of top 102. FIG. 1C shows an interior view of polymeric container closure 120, with top 102 (seen from the interior) and circular wall 104. Top 102 is solid. Ridges 106 extend from the exterior of circular wall 104, and threads 108 extend from the interior of the circular wall. Structures 122 extend from an interior of the top. FIG. 1D shows an exterior view of polymeric container closure 130, with top 102 (seen from the exterior) and circular wall 104. Top 102 defines through hole 132. Ridges 106 extend from the exterior of circular wall 104.

Polymeric container closures may be modified prior to use as biofilm carriers in a biological filtration system. Modification may include increasing the surface area of a polymeric container closure to facilitate microbial attachment to the polymeric container closure, changing the shape of the polymeric container closure to inhibit nesting of the polymeric container closures, forming through holes in the polymeric container closure to facilitate fluid flow through a biological filtration system, or a combination thereof.

Nesting of polymeric container closures, such as nesting of polymeric container closures 100, 110, and 120 shown in FIG. 2A, may reduce the surface area available for microbial attachment in a biological filtration system. In one example, changing the shape of a polymeric container closure includes softening and reshaping the polymeric container closure (e.g., by heating and then crimping or twisting). The reshaped polymeric container closure has a less regular (irregular) or more complex shape with fewer flat surfaces, making nesting less likely. FIG. 2B shows polymeric container closure 120 and reshaped polymeric container closures 200 and 210. Reshaped polymeric container closures 200 and 210 were formed by heating and deforming polymeric container closures 100 and 110, respectively, and are less likely to nest after deformation. FIG. 2C shows modified polymeric container closure 230 formed by reshaping polymeric container closure 130 shown in FIG. 1D.

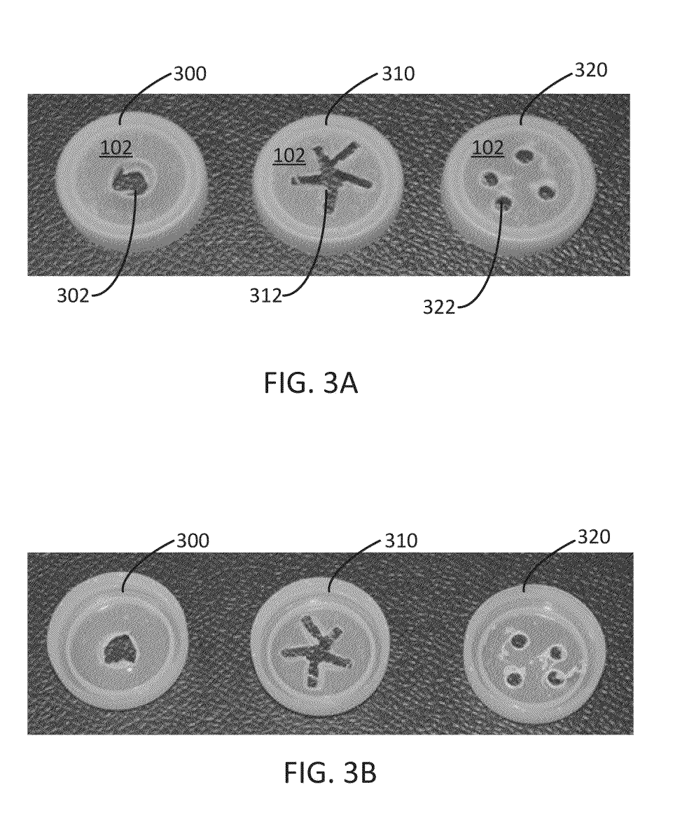

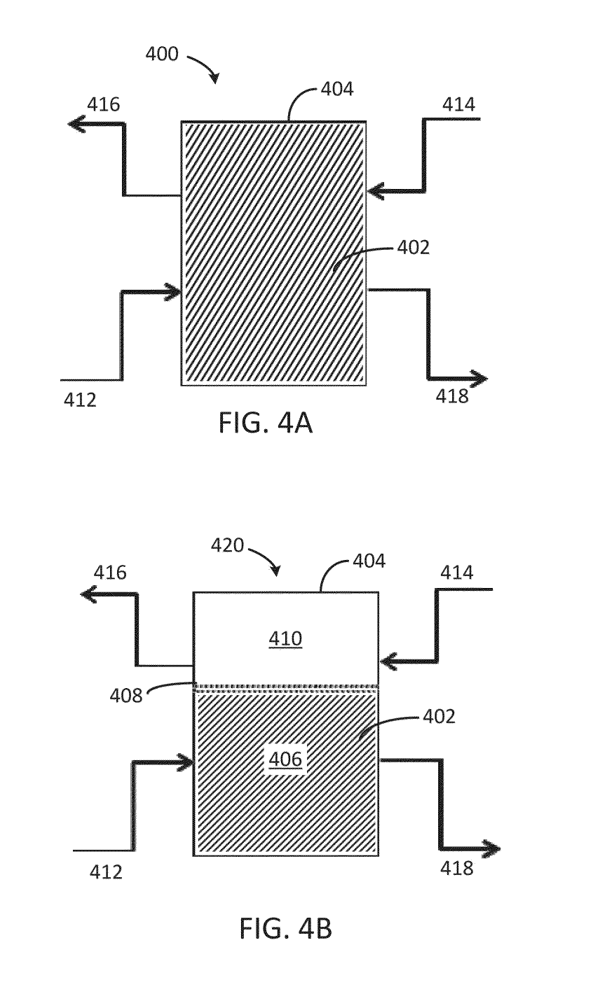

Through holes in a polymeric container closure may be designed with a shape and size suitable to provide the polymeric container closure with desired fluid flow characteristics. One or more openings can be created by drilling, punching, melting, or other suitable means so that a portion of the polymeric container closure is modified to allow a desired fluid flow path from the interior of the polymeric container closure through the top to the exterior of the polymeric container closure or vice versa. FIG. 3A shows an exterior view of modified polymeric container closures 300, 310, and 320. Top 102 of polymeric container closure 300 has been modified to define a single through hole 302. Top 102 of polymeric container closure 310 has been modified to define a single through hole 312 with a complex shape. Top 102 of polymeric container closure 320 has been modified to include a plurality of through holes 322. FIG. 3B shows an interior view of modified polymeric container closures 300, 310, and 320.

Additional surface area for microbial attachment and growth may be created in the process of forming through holes in a polymeric container closure. The process of forming the through hole or fluid flow path can shape the polymeric container closure on the edges of the through hole to create additional surface area for microbial attachment, reducing the amount total available surface area lost by formation of the through hole. In one example, a heated die is used to create fluid passages and reform the plastic of the polymeric container closure such that the material removed from the opening forms additional surface area. In certain cases, a polymeric container closure is modified by scoring, crimping, indenting, cutting, shredding, or the like, to alter its shape, size, surface area, etc., thereby providing enhanced properties for biofilm attachment.

Polymeric container closures can be used as biofilm carriers in biological filtration systems to provide a support for microbial growth. The resulting microbial growth adheres to the polymeric container closures in a layer, or biofilm, and absorbs and metabolizes contaminants, including nitrogen-containing organic compounds (fixed nitrogen) and organic compounds responsible for biochemical oxygen demand (BOD) and chemical oxygen demand (COD). The products of this metabolic action include carbon dioxide, water, nitrogen, and methane.

Biological filtration systems can be used in aerobic, anoxic, and anaerobic treatment of water (e.g., water purification). Biological filtration systems can also be used to remove contaminants from gases, such as air. Examples of biological filtration systems include fill and drain systems, moving bed biofilm reactors (MBBR), trickling filters (TF), biological air scrubbers (BAS), and integrated fixed-film activated sludge (IFAS) reactors. Traditionally, some biological filtration systems, such as tidal drain and fill wastewater plants, use gravel as a biofilm media. The weight of the gravel media generally prohibits the gravel media from being fluidized. Lightweight media, such as polymeric container closures, can be fluidized to release sediments that build up over time in the media bed.

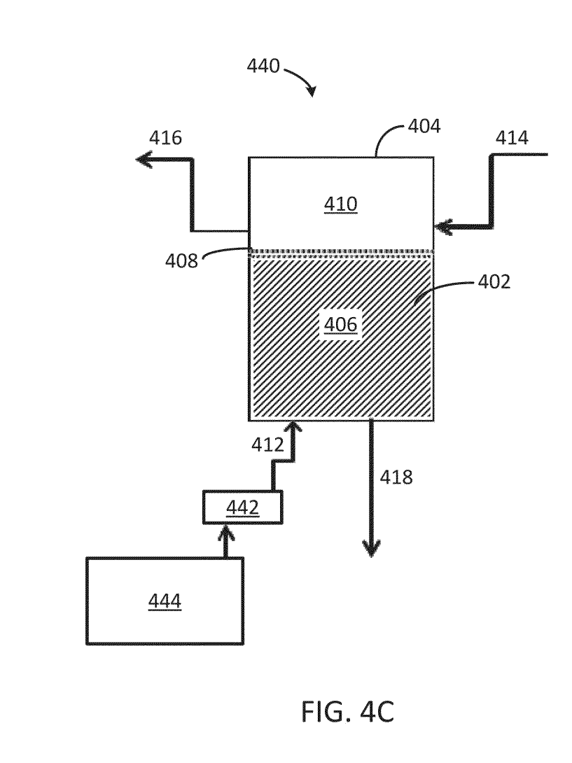

FIG. 4A depicts a biological filtration system 400 with a multiplicity of polymeric container closures 402 in reservoir 404 of the filtration system. The multiplicity of polymeric container closures may include polymeric container closures of a variety of sizes, shapes, and chemical composition. The multiplicity of polymeric container closures 402 is found throughout reservoir 404, and may float or circulate in the aqueous liquid present in the reservoir. In some cases, the multiplicity of polymeric container closures 402 is packed in reservoir 404, and the polymeric container closures remain substantially stationary.

FIG. 4B depicts a biological filtration system 420 in which the multiplicity of polymeric container closures 402 is confined to a selected region or volume 406 of reservoir 404 with porous barrier 408. In one example, barrier 408 is a screen, with openings sized to allow fluid flow from volume 406 to headspace or volume 410, or vice versa, while containing the multiplicity of polymeric container closures 402 in the selected region 406 of the reservoir 404. Volume 410 of the reservoir is typically void of polymeric container closures. Porous barrier 408 may be used when the polymeric container closures are less dense than water and a static condition is desired.

Biological filtration systems 400 and 420 may be open to air (e.g., at the top of the reservoir), and may include one or more fluid inlets and one or more fluid outlets. As depicted in FIGS. 4A and 4B, biological filtration systems 400 and 420 include fluid inlets 412 and 414 and fluid outlets 416 and 418. The placement fluid inlets and outlets is not limited by the depiction in FIGS. 4A and 4B. One or more fluids may be provided to reservoir 404 of biological filtration systems 400 and 420 via fluid inlet 412, 414, or both. When two or more fluids are provided to biological filtration system 400, one of the fluids may be a gas.

In some cases, a biological filtration system includes a pump coupled to one or more of the fluid inlets and fluid outlets. FIG. 4C depicts biological filtration system 440 with pump 442 fluidically coupled to reservoir 404 and basin 444. Pump 442 provides aqueous liquid (e.g., wastewater or other water to be treated) from basin 444 to reservoir 404 via inlet 412. Treated aqueous liquid may be drained from reservoir 404 via fluid outlet 418. In some cases, (e.g., when reservoir 404 is open to the atmosphere), biological filtration system 440 includes fluid inlet 412 and fluid outlet 418 to the exclusion of other inlets and outlets. In other cases, biological filtration system 440 includes one or more additional fluid inlets and/or one or more additional fluid outlets, such as fluid inlet 414 and fluid outlet 416.

In one implementation, biological filtration system 400 is a dynamic or continuous flow system, such as a moving bed biofilm reactor (MBBR) or an integrated fixed film activated sludge system (IFAS). An aqueous liquid, such as wastewater or other water to be treated, is provided to reservoir 404 through fluid inlet 414, promoting biofilm growth on the multiplicity of polymeric container closures 402 and thereby removing contaminants from the aqueous liquid. When the aqueous liquid is wastewater is derived from sewage, microbes and contaminants on which the microbes feed present in the wastewater form a biofilm on the surfaces of the polymeric container closures. When the aqueous liquid lacks microbes, a source of microbes from a wastewater treatment plant or commercial preparation may be added to provide an initial seeding of microbes for the creation of biofilm. Air is provided to reservoir 404 through fluid inlet 412, fluidizing the multiplicity of polymeric container closures 402, and exits through fluid outlet 416. The treated aqueous liquid exits reservoir 404 via outlet 418 as additional aqueous liquid is provided to the reservoir 404.

In another implementation, biological filtration system 400 is a static or batch system, such as a fill and drain system. A batch of an aqueous liquid, such as wastewater or other water to be treated, is provided to biological filtration system 420 via fluid inlet 412 or 414 to fill selected region 406 of the biological filtration system. As the aqueous liquid is provided to biological filtration system 420, air leaves reservoir 404 through outlet 416. Microbes in the aqueous liquid attach to the multiplicity of polymeric container closures, and biofilm growth is supported by contaminants (e.g., carbon-containing compounds) in the aqueous liquid, yielding a treated aqueous liquid. At a selected interval of time, the treated aqueous liquid is drained from reservoir 404 via fluid outlet 418. Air flows in via fluid inlet 414 to displace the volume of the treated water drained from reservoir. Oxygen in the air is absorbed by the biofilm on the polymeric container closures. After exposure of the biofilm to air for a selected length of time, the initial (or a subsequent) batch of aqueous liquid is provided to reservoir 404. Cycled liquid remaining in the reservoir, and the microbes therein, facilitate rapid biofilm growth in the subsequent cycle of the fill and drain system.

In another implementation, biological filtration system 420 or 440 is a dynamic system, such as a trickling filter. An aqueous liquid, such as wastewater or other water to be treated, is provided to biological filtration system 420 via fluid inlet 414 to selected region 406 of the biological filtration system, passing through the multiplicity of polymeric container closures 402 and out fluid outlet 418. Air enters biological filtration system 420 via inlet 412 or 414 and exits via fluid outlet 416 or 418. Microbes in the aqueous liquid attach to the multiplicity of polymeric container closures 402, and biofilm growth is supported by contaminants (e.g., carbon-containing compounds) in the aqueous liquid.

In another implementation, biological filtration system 420 or 440 is a dynamic system, such as a biological air scrubber. An aqueous liquid, such as wastewater or other water to be treated, is provided to biological filtration system 420 via fluid inlet 414 to selected region 406 of the biological filtration system, passing through the multiplicity of polymeric container closures 402 and out fluid outlet 418. Air enters biological filtration system 420 via inlet 412, flows through the aqueous liquid and the multiplicity of polymeric container closures 402 in selected region 406, and exits via fluid outlet 416. Microbes in the aqueous liquid attach to the multiplicity of polymeric container closures 402, and biofilm growth is supported by carbon-containing compounds in the aqueous liquid. The biofilm absorbs contaminants in the air such as hydrogen sulfide, mercaptans, volatile fatty acids, and alcohols, thereby removing odors from the air flowing through the biological filtration system.

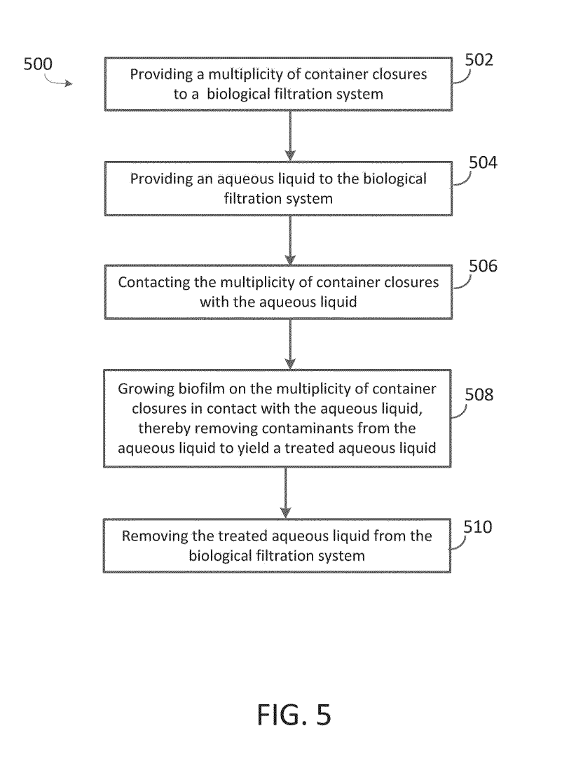

FIG. 5 is a flow chart showing process 500 for treating an aqueous liquid in a biological filtration system. In 502, a multiplicity of polymeric container closures (hereinafter “polymeric container closures”) is provided to a biological filtration system. The polymeric container closures may be confined in a region of the biological filtration system with a porous barrier. In 504, an aqueous liquid is provided to the biological filtration system, and in 506 the polymeric container closures are contacted with the aqueous liquid. Microbes in the aqueous liquid contact the polymeric container closures and attach thereto. Contaminants in the aqueous liquid (e.g., carbon-containing compounds) are metabolized by the microbes attached to the polymeric container closures, thereby promoting biofilm formation and growth. In some cases, a gas (e.g., air in a biological air scrubber) is provided to the biological filtration system, thereby removing contaminants from the air. In 510, the treated aqueous liquid (i.e., the aqueous liquid from which contaminants have been removed by the microbes in the biofilm), or at least some of the treated liquid, is removed from the biological filtration system. Removal of the aqueous liquid can be a continuous process, as in a trickling filter or a moving bed biofilm reactor, or a batch process, as in a fill and drain system.

In some implementations, portions of process 500 are omitted. For example, operation of an established biological filtration system may not require the addition of polymeric container closures in 502. In other implementations, process 500 includes additional features, such as providing a gas to the biological filtration system, as discussed herein with respect to biological air scrubbers. The aqueous liquid may be provided to and removed from the biological filtration system continuously, as in a trickling filter, or batch-wise, as in a fill and drain system. In some cases, the aqueous liquid is provided to and removed from the biological filtration system simultaneously, as in a trickling filter.

### EXAMPLE

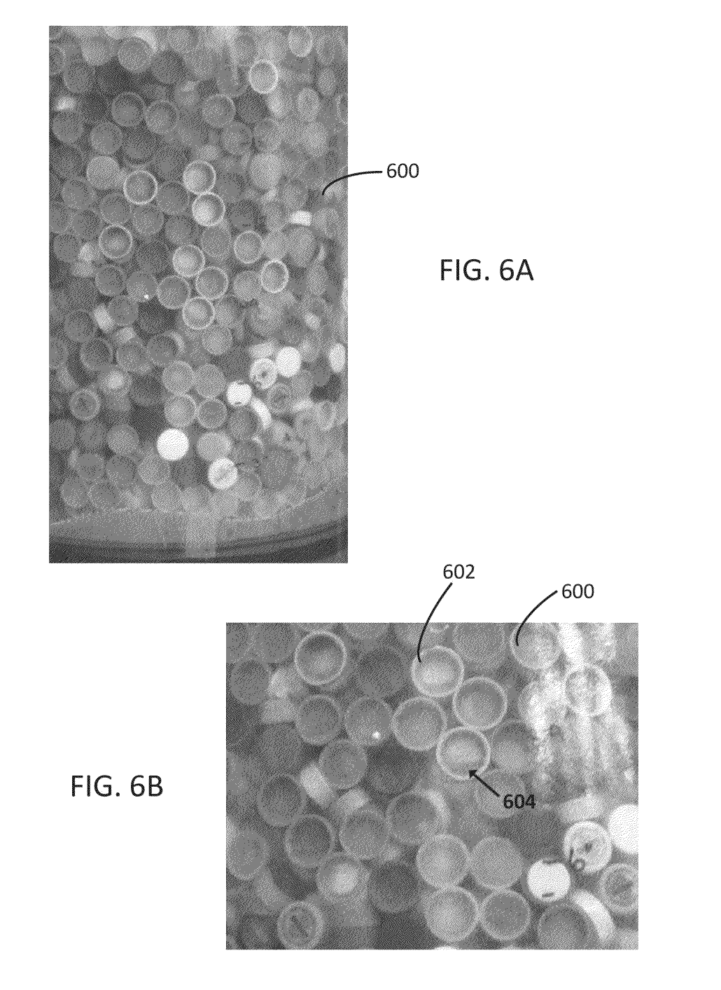

A multiplicity of polymeric container closures were loaded into a tidal fill and drain reservoir shown, such as that depicted in FIG. 4C. The volume of the reservoir containing the polymeric container closures was approximately 25 gallons. The reservoir was open to the air on top, and a pump and valve were provided at a fluid inlet and fluid outlet, respectively, at the bottom of the reservoir. FIG. 6A shows an image of polymeric container closures 600 packed in the biological filtration system. FIG. 6B shows polymeric container closures 600 in the biological filtration system after water was drained from the system. Biofilm 602 is visible on the polymeric container closures 600. Treated water 604 was retained in the interior of some of the polymeric container closures after the system was drained.

The biofilm seen in FIG. 6B was grown according in the biological filtration system under the following experimental conditions, and the system was monitored over five months.

During the first four months, every weekday afternoon, approximately 5 gallons of water was added to the system, which pushed 5 gallons of treated water out of the system. For the first four months, the daily feed (25 g whey, 17 g NH₄Cl, and 9 g NaCHO₃) was added to the basin after the addition of the water. On Friday afternoons, the system was given a double daily feed dose and not fed again until late Monday afternoon. The daily cycle rate was 48 cycles/day. In each cycle, the reservoir was drained of water for 900 seconds and then the pump was operated for 28 seconds to fill the reservoir with the prepared aqueous feed. The water remained in the reservoir and in contact with the biofilm on the polymeric container closures for 900 seconds, and then the cycle was repeated.

During the last month, a portable sump pump was used every weekday afternoon to drain all the water from the basin while the reservoir was empty. The same volume of fresh tap water was added to the system prior to the addition of the daily feed (25 g whey, 17 g NH₄Cl, and 9 g NaCHO₃, increasing to 18 g NaCHO₃ about half-way through the fifth month due to low pH). The system was drained and fed every weekday afternoon. The cycle rate was 24 cycles/day. In each of these new cycles, the reservoir was drained of water for 1800 seconds, and then the pump operated for 20 seconds to fill the reservoir with the prepared aqueous feed. The water remained in the reservoir and in contact with the biofilm on the polymeric container closures for 1800 seconds, and then the cycle was repeated.

The loading rate was 375 g chemical oxygen demand (COD) per cubic meter per day and 65 g of nitrogen (N) per cubic meter per day, or 1486 milligrams per liter COD and 258 milligrams per liter Total Kjeldahl Nitrogen (TKN).

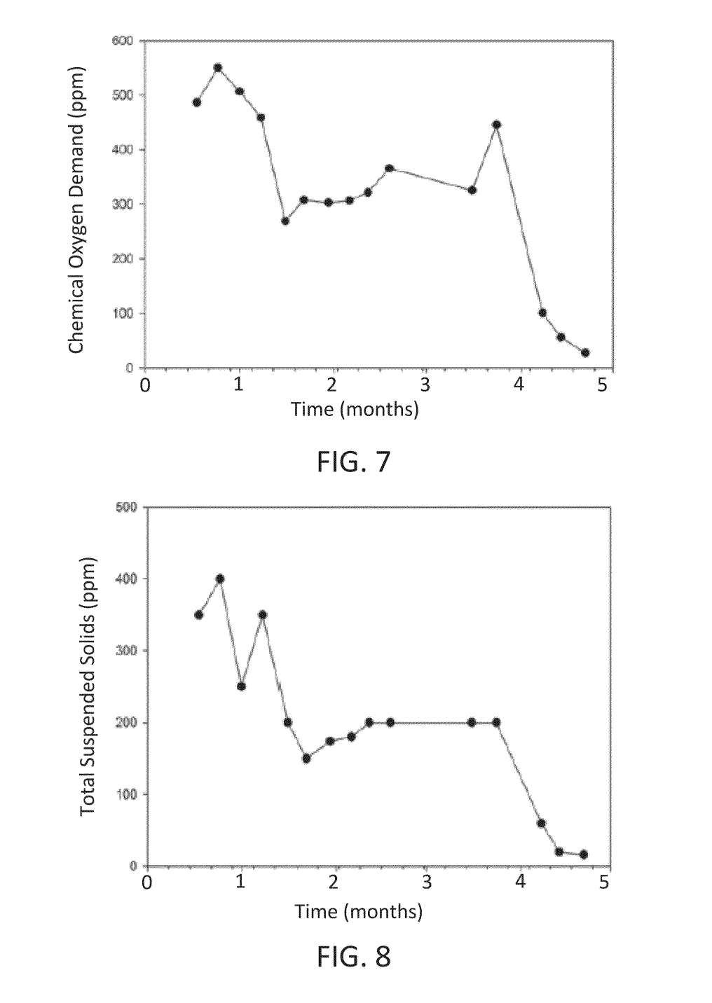

FIG. 7 shows the chemical oxygen demand (COD) of the treated wastewater versus elapsed time in months. Chemical Oxygen Demand (COD) is a measurement of the organic matter content in a water sample determined by the amount of oxygen consumed per liter of solution (mg/L). The COD test utilizes a chemical oxidant in an acid solution, which is then heated in order to oxidize the carbon to CO₂ and water. After a heated reaction period of greater than 1 hour, each sample was then measured using a photometer. The change of the fill and drain timing interval at the beginning of the fifth month caused a noticeable drop in the COD.

FIG. 8 shows the total suspended solids (TSS) versus elapsed time in months. TSS was determined by using a known volume of water filtered through a pre-weighed glass fiber filter using a vacuum pump. The filter is then dried for 1 hour at 100° C. and then re-weighed. The result is a measurement of the TSS in milligrams per liter. The TSS removal showed improvement in the fifth month.

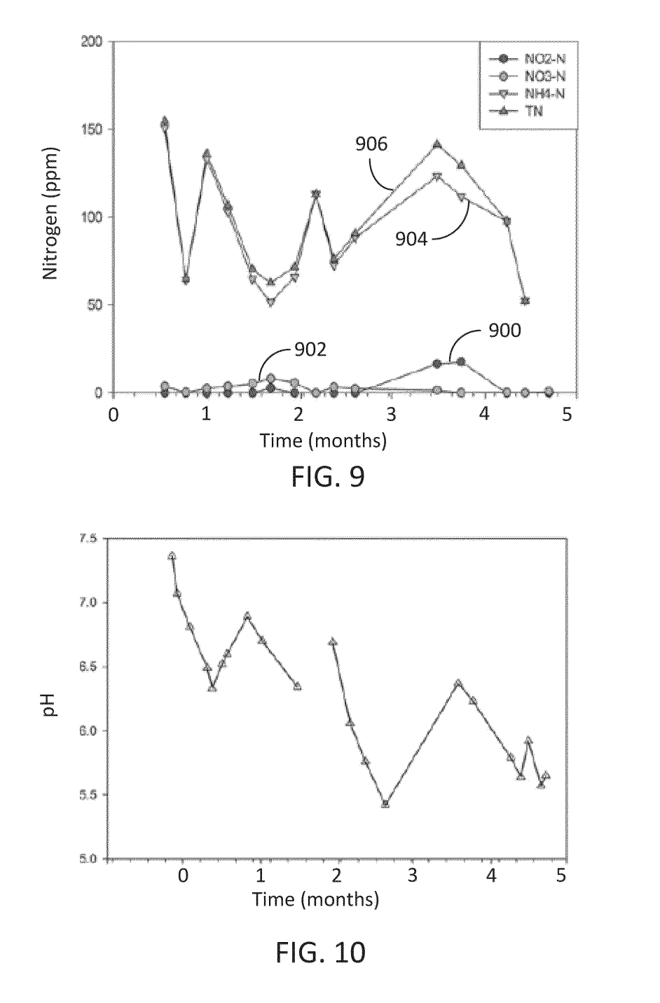

FIG. 9 shows the concentration of nitrogen species in the water versus elapsed time in months, again with significant improvement in performance over the last month. Plots 900, 902, 904, and 905 refer to nitrite, nitrate, ammonia, and total nitrogen, respectively. Nitrogen species were measured using a Dionex ion chromatograph used to separate molecules by charge. The varying concentrations of nitrate, nitrite and ammonium in a sample are used as an indicator of microbial processes. Biological oxidation of ammonia and organic nitrogen to ammonium, then into nitrite and nitrite into nitrate is a process called nitrification. Denitrification is the microbial process of nitrate reduction to dinitrogen (N₂).

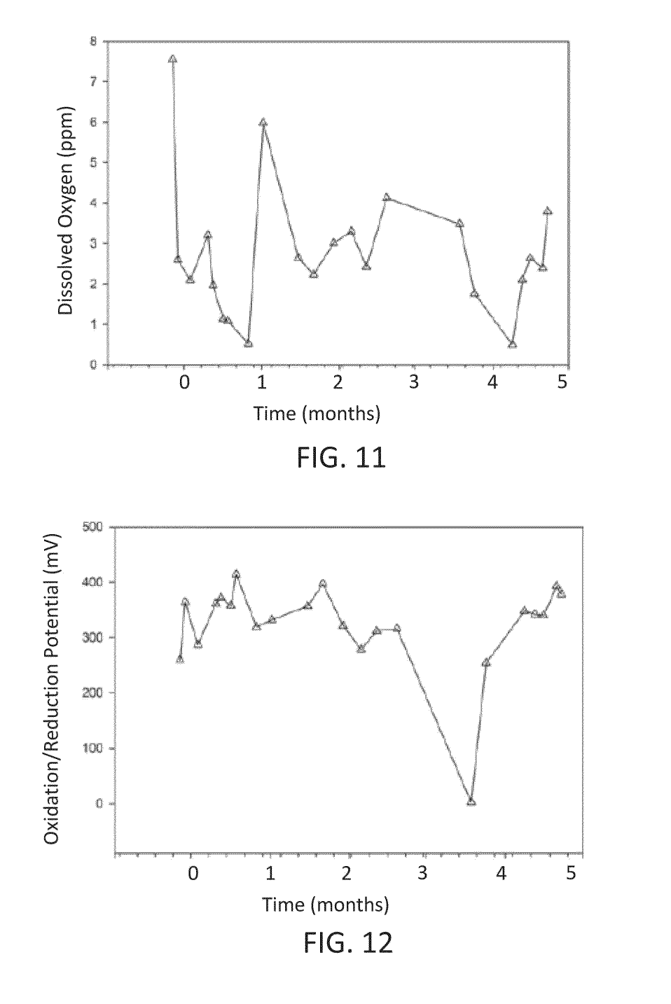

FIG. 10 shows the pH of the treated wastewater over five months, with the nitrification in FIG. 9 corresponding to an increase in pH in the third month. FIG. 11 shows the concentration of dissolved oxygen (DO) versus elapsed time in months. FIG. 12 shows the oxidation-reduction potential (ORP) versus elapsed time in months. The pH, DO and ORP were measured using probes attached to laboratory instruments.

These data, along with the visual inspection of the polymeric container closures indicate the presence of a biofilm on the surfaces of the polymeric container closures, and activity of the biofilm in the treatment of the wastewater in the tidal fill and drain system.

A number of embodiments have been described. Nevertheless, it will be understood that various modifications may be made without departing from the spirit and scope of the invention. Accordingly, other embodiments are within the scope of the following claims.

What is claimed is:

1. A method of treating an aqueous liquid in a biological filtration system, the method comprising:
providing an aqueous liquid to the biological filtration system, wherein the biological filtration system comprises biofilm carriers in the form of polymeric container closures;
contacting the polymeric container closures with the aqueous liquid;
growing biofilm on the polymeric container closures in contact with the aqueous liquid, thereby removing contaminants from the aqueous liquid to yield a treated aqueous liquid; and
removing at least some of the treated aqueous liquid from the biological filtration system.

2. The method of claim 1, further comprising providing the multiplicity of polymeric container closures to the biological filtration system.

3. The method of claim 1, wherein providing the aqueous liquid to the biological filtration system and removing the treated aqueous liquid from the biological filtration system occur simultaneously.

4. The method of claim 1, wherein providing the aqueous liquid to the biological filtration system and removing the treated aqueous liquid from the biological filtration system occur continuously.

5. The method of claim 1, further comprising flowing a gas to be treated through the aqueous liquid.

6. The method of claim 1, wherein the aqueous liquid comprises microbes, and growing the biofilm comprises attaching the microbes to the polymeric container closures.

7. The method of claim 1, further comprising confining the polymeric container closures to a selected region of the biological filtration system with a porous barrier.

8. The method of claim 1, wherein the polymeric container closures are reclaimed.

9. A method of making biofilm carriers for a biological filtration system, the method comprising modifying a polymeric container closure to yield a biofilm carrier, wherein modifying the polymeric container closure comprises altering the shape of the polymeric container closure, forming a through hole in each polymeric container closure, or a combination thereof.

10. Biofilm carriers formed by the method of claim 9.

11. A biological filtration system comprising biofilm carriers formed by the method of claim 9.

12. A biological filtration system comprising:
a reservoir configured to receive an aqueous liquid;
a multiplicity of polymeric container closures in the reservoir;
a fluid inlet fluidically coupled with the reservoir, such that an aqueous liquid provided to the reservoir via the fluid inlet contacts the multiplicity of polymeric container closures; and
a fluid outlet fluidically coupled with the reservoir.

13. The biological filtration system of claim 12, wherein the multiplicity of polymeric container closures is reclaimed.

14. The biological filtration system of claim 12, wherein a through hole is defined in each polymeric container closure of the multiplicity of polymeric container closures.

15. The biological filtration system of claim 12, wherein the shape of each polymeric container closure of the multiplicity of polymeric container closures has been modified by softening and deforming the polymeric container closure.

16. The biological filtration system of claim 12, wherein the multiplicity of polymeric container closures comprises polymeric container closures in a variety of shapes and sizes.

17. The biological filtration system of claim 12, wherein the fluid inlet provides a continuous flow of the aqueous liquid to the reservoir.

18. The biological filtration system of claim 12, wherein the fluid inlet provides a batch-wise flow of the aqueous liquid to the reservoir.

19. The biological filtration system of claim 12, further comprising an additional fluid inlet for providing gas to the reservoir and an additional fluid outlet for removing gas from the reservoir.

20. The biological filtration system of claim 12, wherein the multiplicity of polymeric container closures is confined to a region of the reservoir by a porous barrier.
